(19) United States
(12) Patent Application Publication
(10) Pub. No.: US 2021/0337844 A1
(43) Pub. Date: Nov. 4, 2021

(54) Prebiotic Fiber Bars and Method of Making

(71) Applicant: Daniel William Harrell, Hallandale, FL (US)

(72) Inventor: Daniel William Harrell, Hallandale, FL (US)

(21) Appl. No.: 16/861,806

(22) Filed: Apr. 29, 2020

(51) Int. Cl. A23L 25/00; A23L 7/126; A23L 33/135; A23L 33/15; A23L 33/29; A23L 33/115; A23P 10/00; A23P 20/10; A23L 5/10

(52) U.S. Cl. CPC A23L 25/30; A23L 7/126; A23L 33/135; A23L 33/15; A23L 5/10; A23L 33/115; A23P 10/00; A23P 20/10; A23L 33/29

(57) ABSTRACT

Snack bars incorporating more than 4 grams of prebiotic fiber derived from Chicory root fiber and methods of making such snack bars are described herein. The snack bars may incorporate chicory root fiber, coconut, dried fruits, with or without, nuts pieces, chocolate, seeds, probiotics, vitamins, minerals, herb, spices, and oils held together by a binder comprising chicory root fiber and may be enrobed with chicory root fiber as the outer coating. The methods may include mixing chicory root fiber into a binder made with honey and or syrup, mixing binder with a creamy crunchy chewy grain composition, add any additional ingredients, press into desired thickness, cut into bars, enrobe bars with treatments of chicory root fiber, and heat treatment processes to melt the chicory root fiber and form a uniform glossy surface that is appealing to the customer, and reducing water activity.

### FIELD OF THE INVENTION

The field of the present invention relates to foodstuffs for human consumption, more particular the incorporation of a prebiotic fiber into products composed solely from plant derived ingredients or a mixture of plant derived ingredients with improvements in sensory and nutritional properties. The present invention relates to a new concept for healthy snack bars. The object of the present invention is to create a consumer snack bar having a size in weight of 40 grams per serving and containing more than 4 grams of prebiotic fiber per serving derived from chicory root fiber powder as the outer coating on a non-baked core which have favorable health effects as simply and effectively as possible without giving up what consumers prefer (e.g., sweetness taste of food/texture).

### BACKGROUND OF THE INVENTION

The present invention relates to a snack bar using Chicory root fiber powder an Inulin also a natural prebiotic dietary fiber, as the outer coating on the snack bar and used as a sugar replacement while having the sweet and structural properties of a common snack bar. More particularly, the present invention relates to a solid or a semi-solid snack bar that can be used as a replacement snack bar on a 1/1 weight basis and/or on a 1/1 volume basis. Inulin is a water-soluble storage polysaccharide and belongs to a group of non-digestible carbohydrates called fructans. Inulin has attained the GRAS status in USA and is extensively available in about 36,000 species of plants, among these species of plants chicory is considered the richest source of inulin. Commonly, inulin is used as a prebiotic, fat replacer, sugar replacer, texture modifier also beneficial for the development of functional foods to improve health due to its role in gastric health. Additionally, it is used here as a functional ingredient in novel product.

More particularly, the present invention relates to a solid or a semi-solid snack bar that can be used as a replacement snack bar aiding in fiber consumption. Fewer than 5% of people get enough fiber from their diet.

The main purpose is to replace food ingredients that are used in most snack bars and at the same time cause harmful poisons to humans (even healthy people) with a snack bar comprising more than 4 grams of prebiotic fiber derived from the outer coating of chicory root fiber powder that can be made in various flavored varieties and shapes having an appealing thick, crunchy, glass-like glossy outer coating after given a rapid high heat process that can be done with ease at home. One of the most widely used ingredients in this context is inulin derived

### BREIF SUMMARY OF THE INVENTION

Sugar is used as a common sweetener in human food preparations. Sugar is also considered to be sucrose. Other widely used high calorie sweeteners are glucose, fructose, and high fructose corn syrup. In general eating habits there are tendencies to consume excessive sugar. However, especially because of its high caloric content, high sugar intake is not preferred for dietary reasons. The most common adverse health effects of sugar are tooth decay and obesity. The rapid introduction of high fructose corn syrup into the food supply in the 1970s (especially in soft drinks) has been recognized as an important factor contributing to the prevalence of obesity that has spread worldwide over the past 30 years. In addition, people with diabetes need to reduce their sugar intake. The presence of high levels of glucose in the blood is harmful. Even if symptoms do not become acute immediately, over time uncontrolled high blood sugar levels can damage smaller blood vessels, including irreversible damage to the eyes and kidneys. Nerves can also be damaged which can adversely affect the internal organs as well as the ability to feel sensations and pain. Uncontrolled diabetes increases the risk of cardiovascular disease (heart attack). Therefore, it is extremely important to be able to use sugar substitutes instead of common food products. One type of sugar substitute is Chicory root fiber powder, a prebiotic fiber known for its healthy bifidogentic effects.

Unfortunately, Americans consume less than half of the recommended daily fiber amount (38 and 25 g/day for men and women aged 19-50, respectively) and fewer than 5% of people get enough fiber from their diet. Thus, many consumers want convenient foods and supplements, including snack bars that are a good source of fiber and many consumers are interested in consuming more Inulin due to its prebiotic fiber health benefits.

Inulin is a hypoglycemic agent. Since it is not digestible by human enzymes ptyalin and amylase, inulin passes through much of the digestive system intact. It is only in the colon that bacteria metabolize inulin, with the release of significant quantities of carbon dioxide and/or methane. Because inulin is not broken down into simple sugars (monosaccharides) by normal digestion, it does not elevate blood sugar levels, hence helping diabetics regulate blood sugar levels. From this perspective, the complex micro floras are present as part of the healthy human body in the gastrointestinal tract (61 tract), more specifically the colon. In the gastrointestinal tract, microorganisms are prevalent in the colon, and these microorganisms constitute about 10¹¹ to 10¹² g of the colon contents.

### BREIF SUMMARY OF THE INVENTION

It is well known, microorganisms in the large intestine complete the digestion process for food components that were not digested in the small intestine for example, fibers that are oligosaccharides and polysaccharides are most often plant-derived food substances. The properties of these oligosaccharides and polysaccharides depend on, for example, saccharide composition, linkages between saccharides, and the degree of polymerization (DP).

Prebiotic fibers are mainly non-digestible soluble oligosaccharides and soluble polysaccharides. Some of these fibers that have prebiotic properties are called prebiotic fibers, prebiotic oligosaccharides, or prebiotic polysaccharides. Non-digestible means that it is not digested by human enzymes in the GI tract and is not absorbed into the upper digestive tract. Thus, non-digestible soluble oligosaccharides and soluble polysaccharides remain unchanged and reach the colon, where at least some of the useful bacteria (e.g., Bifidobacteria and Lactobacilli) utilize prebiotic fibers as a selective energy source for growth and proliferation in the colon.

This action is called a prebiotic action and represents the stimulation and/or activation of health promoting bacteria in the intestinal tract. For example, research on humans has confirmed that taking moderate amounts of prebiotic fiber significantly increases the number of bifidobacteria in the colon (up to 10 times). During fermentation, these fibers are broken down to produce short chain fatty acids (SCFA), which lowers the pH level and provide an energy source for the growth and maintenance of colon cells. This process leads to differentiation of the cancer cells (an important step required before killing the cancer cells). As a result of the pH-lowering effect of acid generation, the intake of calcium and magnesium is improved.

### BREIF SUMMARY OF THE INVENTION

Currently on the market there are processes to make food bars containing prebiotic fiber in various amounts; these food bars include the prebiotic fiber in the bar's core and or in the outer coatings. These processes often include mixing chicory root fiber syrup with other additives such as yogurts, and/or flavorings together as the mix used for the outer coating on food bars and they are given heat treatments at lower temperatures for longer periods of time to evaporate the water in the outer coating mix often resulting in a thin frosting glaze like outer coating. While it is possible using the current processes to give multiple heat treatments with multiple layers comprising of chicory root fiber syrup as the outer coatings at lower temperatures for longer periods of time to the food bar, these multiple heat treatments are highly inefficient and often ineffective resulting in the food bar unappealing to the consumer.

Other examples of existing processes on the market may use chicory root fiber syrup which is not a semi-crystalline as the outer coating or coatings on a food bar and the bars are given Rapid High Heat Treatments for Less Periods of Time, these treatments often result in the caramelization of the outer coatings on the food bars making the food bars unappealing to the consumer.

It is therefore an object of the present invention to overcome at least one of the above problems. In the present invention the outer coatings of the food bar have a thick, crunchy, glass-like, glossy outer coating and the outer coating comprising chicory root fiber powder a (semi-crystalline) and is given rapid high heat treatments wherein as referred to in this study “The Complex melting of semi-crystalline chicory intybus root inulin” (PMID 9794072) shows us the crystallites in semi-crystalline chicory root inulin resulting from primary nucleation at higher temperatures are larger than those resulting from secondary nucleation at lower temperatures. The resulting effect of to the food bar from the higher temperature process to the outer coating made of semi-crystalline chicory root fiber powder is a thick, crunchy, glass-like glossy outer coating on the food bar thus appealing to the consumer.

### DETAILED DESCRIPTION

The object of the present invention is to create a consumer snack bar having a thick, crunchy, glass-like glossy outer coating on the snack bar with a creamy grain non-baked core having a weight of 40 grams per serving size and containing more than 4 grams of prebiotic fiber derived from the outer coating of chicory root fiber powder used on the snack bar. Various combinations of the snack bars core can be produced, and still further various combinations of outer coatings comprising chicory root fiber powder mixed with dried components on the snack bar can be produced still containing more than 4 grams of the prebiotic fiber derived from the outer coating of chicory root fiber powder which has never been done before, also having favorable health effects as simply and effectively as possible.

Embodiments of the invention are directed to an agglomerated snack bar with a creamy texture. The agglomerated snack bar comprise dry (particulate) ingredients bound together with an aqueous solution (binder) to produce a snack bar core. The binder agglomerates the entire snack bar core ingredients and adds taste and texture to the base raw materials in the snack bar's core. The taste and texture of the particulates in the agglomerated snack bar core can be adjusted to suit consumers preference. Further forming the snack bars core to a desired shape and cooling the snack bar core.

The formulation of the product is such that there is no requirement to sheet the product prior to forming, which is the case with conventionally produced snack bars on the market. Instead, the product can be formed directly from the food mass and the formed pieces retain their shape after cooling and during subsequent processing steps. Still further coating the snack bar core with chicory root fiber powder as the outer coating and given rapid heat treatment processes. The taste and texture of the particulates in the snack bars outer coating can be agglomerated with dry ingredients and adjusted to suit consumers preference.

According to the present invention, there is provided, as set out in the appended claims, an outer coating for a snack bar comprising chicory root fiber powder from about 10% wt. to about 15% wt. of the snack bar.

In some embodiments, the snack bar further comprises seeds held together with the chicory root fiber powder as the outer coating.

In some embodiments, the snack bar further comprises nuts held together with the chicory root fiber powder as the outer coating.

In some embodiments, the snack bar further comprises nuts and seeds held together with the chicory root fiber powder as the outer coating.

### DETAILED DESCRIPTION

In some embodiments, the snack bar further comprises cocoa powder held together with the chicory root fiber powder as the outer coating.

In some embodiments, the snack bar further comprises cereal held together with the chicory root fiber powder as the outer coating.

In some embodiments, the snack bar further comprises cereal and nuts held together with the chicory root fiber powder as the outer coating.

In some embodiments, the snack bar further comprises cereal, nuts, and seeds held together with the chicory root fiber powder as the outer coating.

One aspect of the snack bar comprises mixing coconut cream with or without dried fruit pieces, nut pieces, cereal, grain, chocolate, pregelatinized starch, seeds, dried vegetables, probiotic, vitamins, minerals, antioxidants, herbs, spices, plant oils or any combinations thereof, and still further mixed with and held together by a binder comprising honey and or syrup, with or without pregelatinized starch, probiotic, vitamins, minerals, antioxidants, herbs, spice, plant oils or any combinations thereof, to formulate a snack bar core base mix.

In some embodiments, the binder comprises a syrup. In some embodiments, the binder comprises a honey. In some embodiments, the binder is derived from Honey, and or Agave syrup, Rice syrup, Date syrup, Oat syrup, Barley Malt syrup, Maple syrup, Birch syrup, Inulin syrup or any combination thereof.

In some embodiments, the creamy grain composition comprises coconut cream, discrete pieces of nuts, and dried fruits, with or without chocolate, spices, seeds, herbs, probiotics, vitamins, minerals, and or oils, or any combination thereof and comprises from about 75% wt. to about 90% wt. of the snack bar.

Another aspect of the snack bar the discrete pieces of pieces of fruit, nuts, with or without chocolate, and or seeds, have a diameter of between about 6 and about 16 mm and/or a volume of between about 30 and about 150 mm. In some embodiments, pieces of fruit, nuts, with or without chocolate, and or seeds, or any combination thereof, are held together in the creamy, chewy, grain composition by the binder, and the pieces of fruit, nuts, chocolate, seeds, or combination thereof have an average diameter between about 4 and about 16 mm and/or an average volume between about 10 and about 600 mm.

### DETAILED DESCRIPTION

In some embodiments, the binder comprises between about 5% wt. to about 15% wt. of the snack bar.

### BRIEF DESCRIPTION OF THE DRAWING

The invention will be more clearly understood from the following description of an embodiment thereof, given by way of example only, with reference to the accompanying drawings in which:

FIG. 1 is a schematic illustrating the manufacturing process used to make the product described herein.

### DETAILED DESCRIPTION OF THE DRAWINGS

The invention broadly relates to a snack bar having a thick, crunchy, glass-like uniform glossy surface that is appealing to the consumer using recipes creating bar cores with varieties of flavors and textures by changing the dry ingredients in the base mix and combined with the varieties of mixtures in the liquid binder, blending the base mix with the liquid binder until the base mix is uniformly coated with the liquid binder. Further forming the mixture to a desired shape then cooling the shaped bar core. Still further, mixing the outer coating mixture with dried ingredients to a desired outer coating mixture. The cooled shaped bar is further treated applying the outer coating mixture to the first or second side of the cooled shaped bar, still further processing the shaped coated cooled shaped bar with a rapid high heat process at a temperature of from about 350° F. to about 750° F. for about 30 seconds to about 3 minutes to melt the outer coating of outer coating mixture and form a pre caramelized thick, crunchy, glass-like uniform glossy surface that is appealing to the consumer.

### DETAILED DESCRIPTION

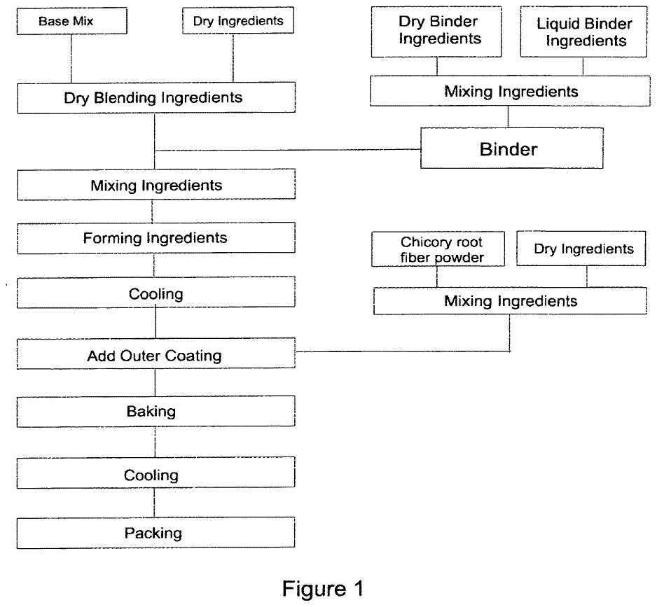

Now turning to FIG. 1 a snack bar product is made, but not limited to this process and equipment type by using the following steps.

Preparation of the Dry Mix: Mix the base mix for a sufficient time to uniformly distribute each ingredient in a mixture.

Add the dry ingredients to the base mix mixture and mix for a sufficient time to uniformly distribute each ingredient.

Preparation of the Binder: Mix the dry binder and the liquid binder ingredients for a sufficient time until all ingredients are uniformly distributed to form the binder.

The prepared binder is added to the base mixture (base mix with dry ingredients) and is mixed for a sufficient time to incorporate and solubilize all the ingredients in the base mixture.

The mixture can then be formed to have a desired shape before or after cooling typically by molding into a desired format. Individual pieces can be cut, punched, or otherwise formed into pieces of the desired shape and size. Similarly, a sheet can be cut into strips, evenly spread on a belt, followed by rolling and shaping as necessary to form individual pieces. The mixture is then cooled.

Preparation of the outer coating:

Mix the chicory root fiber powder with dried ingredients for a sufficient time to uniformly distribute and form the outer coating mixture. The cooled shaped bar is further treated applying the outer coating mixture to the first or second side of the cooled shaped bar, still further processing the shaped coated cooled shaped bar with a rapid high heat process at a temperature of from about 350° F. to about 750° F. for about 30 seconds to about 3 minutes to melt the outer coating of outer coating mixture and form a pre caramelized thick, crunchy, glass-like uniform glossy surface that is appealing to the consumer. Rapid higher heat treatment processes with temperatures from about 750° F. to about 1500° F. can be used as steadily moving rapid pass treatment to melt the outer coating of the snack bar and form a pre caramelized thick, crunchy, glass-like uniform glossy surface.

### DETAILED DESCRIPTION

The invention will now be particularly described by way of example. However, it will be apparent to one skilled in the art that the specific details are not required to practice the invention. The following descriptions of specific embodiments of the present invention are presented for purposes of illustration and description. They are not intended to be exhaustive of or to limit the invention to precise forms disclosed. Obviously, many modifications and variations are possible in view of the above teachings. The embodiments are shown and described to best explain the principles of the invention and its practical applications to thereby enable others skilled in the art to best utilize the invention and various embodiments with various modifications as are suited to the particular use contemplated.

### EXAMPLE 1

Cranberry Prebiotic fiber snack bars, makes 40 servings (serving size 2 pieces). Mix binder; 184.5 grams of Honey and or syrup together with 823.5 grams coconut cream, 114 grams of cashews pieces, 184.5 grams of dried cranberries, and 114 grams of almond pieces. Mix thorough then compress and cut slab into desired shaped bars weighing 17.75 grams each shaped bar (80 bars). Cool the shaped bars.

Place the cooled bars in bakers pan and add a treatment of chicory root fiber powder weighing 1.25 grams first top side of each bar. Bake or broil or similar heat treatment at a temperature from about 350° F. to about 750° F. for about 30 seconds to about 3 minutes to melt the chicory root fiber powder and form a pre caramelized thick, crunchy, glass-like glossy outer coating. Cool bars.

Place the cooled bars in bakers pan again and add an additional second bottom side treatment of chicory root fiber powder weighing 1.25 grams each bar. Still further bake or broil or similar heat treatment at a temperature about 350° F. to about 750° F. for about 30 seconds to about 3 minutes to melt the chicory root fiber powder and form a pre caramelized thick, crunchy, glass-like glossy outer coating. Cool bars.

### DETAILED DESCRIPTION

### EXAMPLE 2

Blueberry Prebiotic fiber snack bar, makes 40 servings (serving size 1 bar) Mix binder; 184.5 grams of Honey and or syrup together with 823.5 grams coconut cream, 114 grams of cashews pieces, 184.5 grams of dried blueberries, and 114 grams of almond pieces. Mix thorough then compress and cut slab into desired shaped bars weighing 35 grams each shaped bar (40 bars). Cool the shaped bars.

Place the cooled bars in bakers pan and add a treatment of chicory root fiber powder weighing 2.25 grams first top side of each bar. Bake or broil or similar heat treatment at a temperature from about 350° F. to about 750° F. for about 30 seconds to about 3 minutes to melt the chicory root fiber powder and form a pre caramelized thick, crunchy, glass-like glossy outer coating. Cool bars.

Place the cooled bars in bakers pan again and add an additional second bottom side treatment of chicory root fiber powder weighing 2.25 grams each bar. Still further bake or broil or similar heat treatment at a temperature from about 350° F. to about 750° F. for about 30 seconds to about 3 minutes to melt the chicory root fiber powder and form a pre caramelized thick, crunchy, glass-like glossy outer coating. Cool bars.

### EXAMPLE 3

Cinnamon Raisin Prebiotic fiber snack bar, makes 40 servings (serving size 2 pieces).

Mix binder; 184.5 grams of Honey and or syrup together with 823.5 grams coconut cream, 114 grams of cashews pieces, 184.5 grams of dried raisin, and 114 grams of almond pieces. Mix thorough then compress and cut slab into desired shaped bars weighing 17.75 grams each shaped bar (80 bars). Cool the shaped bars.

Place the cooled bars in bakers pan and add a treatment of cinnamon on the first top side of the bar bake or broil or similar heat treatment at a temperature from about 350° F. to about 750° F. for about 30 seconds to about 1 minute to melt the cinnamon. Still further add a treatment of chicory root fiber powder weighing 1.25 grams first top side of each bar covering the melted cinnamon. Bake or broil or similar heat treatment at a temperature from about 350° F. to about 750° F. for about 30 seconds to about 3 minutes to melt the chicory root fiber powder and form a pre caramelized thick, crunchy, glass-like glossy outer coating. Cool bars.

### DETAILED DESCRIPTION

Place the cooled bars in bakers pan again and add an additional second bottom side treatment of chicory root fiber powder weighing 1.25 grams each bar. Still further bake or broil or similar heat treatment at a temperature from about 350° F. to about 750° F. for about 30 seconds to about 3 minutes to melt the chicory root fiber powder and form a pre caramelized thick, crunchy, glass-like glossy outer coating. Cool bars.

### NUTRITION EXAMPLES

Examples# 1, 2, 3. Serving size weight 40 grams.

Calories 227/244/232. Total Fat: 6.2 g/6.2 g/6.2 g-0.09%DV. Saturated Fat:2.8 g/2.8 g/2.5 g-0.135%/0.135%/0.12%DV. Sodium: 2.1 mg/2 .mg/3.1 mg-0.001%/0.001%/0.002%DV. Cholesterol: 0/0/0-0%DV. Total Carbohydrates: 7.8 g/7.7 g/6.50 g-0.03%/0.03%/0.02%DV. Fiber: 5.6 g/6.1 g/5.45 g-0.17%/0.19%/0.17%DV. Sugars: 9.9 g/9.9 g/8.65 g-0.25 %/0.25%/0.22%DV. Total added Sugars: 9.9 g/9.9 g/8.65 g. Protein:0.5 g/0.7 g/2.5 g-0.005%/0.007%/0.03%DV. Vitamin C: 260 mg/262 mg/260 mg-2.77%/2.8%/2.77%DV. Potassium: 45 g/57 g/79 g-0.009%/0.012%/0.016%DV. Choline: 4.8 mg/4.8 mg/2.6 mg-0.008%/0.008%/0.0045%DV. Calcium: 6.7 mg/7.5 mg/9.5 mg-0.005%/0.0055%/0.007%DV. Magnesium: 6.2 mg/7.2 mg/7.7 mg-0.014%/0.016%/0.018%DV. Iron: 28 mg/31 mg/35 mg-1.5%/1.67%/1.9%DV. Folate: 2.85 mcg/3.7 mcg/2.85 mcg-0.007%/0.009%/0.007%DV. Omega 6 Fatty acids: 169 mg/169 mg/188 mg. Prebiotic fiber: 4.5 g/4.5 g/4.5 g-0.17%/0.17%-0.17%.

The % of daily value (DV) tells you how much a nutrient in a serving of food contributes to a daily diet. 2000 calories a day is used for general nutrition advice.

The above description of the invention and the invention has never been done before and is intended to be illustrative and not limiting. Various changes and modifications in the embodiments described may occur to those Skilled in The Arts. These can be made without departing from the spirit or scope of the invention.

1. A snack bar containing more than 4 grams of prebiotic fiber derived from chicory root fiber and the chicory root fiber as the coatings surrounding the bar, and a non-baked core with a creamy, chewy grain composition, comprising coconut cream with dried fruit pieces, with or without, discrete pieces of nuts, seeds, chocolate, spices, herbs, probiotics, vitamins, minerals, and or oils. The creamy, chewy grain composition held together in the form of a bar by a binder comprising a prebiotic fiber “Inulin” from Chicory root fiber, and syrup and or honey, and the coatings from Chicory root fiber surrounding the bar resulting in more than 5 grams of prebiotic fiber in the said bar, with heat treatment processes to the bar to melt the Chicory root fiber to a pre caramelized status and form a uniform glossy surface.

2. The snack bar of claim 1. Where in the creamy, chewy grain composition is non-baked and comprises coconut cream with dried fruits pieces, with or without chocolate, nut pieces, seeds, spices, herbs and oils, or any combination thereof. Wherein the said creamy chewy grain comprises at about 65 to 95% by weight of said bar preferably 86.3%.

3. The snack bar of claim 1, further comprising fruit pieces held together as part of the creamy, chewy grain composition by the binder.

4. The snack bar of claim 1, wherein the binder comprises between about 5% wt. and 40% wt. Inulin from Chicory root fiber by weight of the binder.

5. The snack bar of claim 1, further comprising coconut cream held together as part of the creamy, chewy grain composition by the binder.

6. The snack bar of claim 1, wherein the binder comprises a syrup and or a honey.

7. The snack bar of claim 1, wherein the binder comprises mixing 1.165 gms of chicory root fiber together with 5.5 gms of syrup and or honey at a temperature below about 80° F., and slowly adding the chicory root fiber to the binding syrup. Then, the binding syrup with the added chicory root fiber is heated up above 95° F. to completely dissolve the chicory root fiber in the syrup and or honey.

8. The snack bar of claim 1, wherein nuts pieces, chocolate, seeds, probiotic, vitamins, minerals, spices, herbs and oils are mixed and may be incorporated with the coconut cream, and dried fruit pieces, and held together by the binder.

9. The snack bar of claim 1, wherein, nuts pieces, chocolate, seeds, probiotic, vitamins, minerals, spices, herbs and oils, or any combination thereof are mixed and may be incorporated with the chicory root fiber coatings.

10. The method of claim 1, further comprising compressing the slab to reduce its thickness before cooling.

11. The method of claim 1, further comprising cooling the slab.

12. The method of claim 1, further comprising cutting the slab into bars.

13. The method of claim 1, wherein the bars are Immersed/pre-coated in chicory root fiber.

14. The snack bar of claim 1, wherein an additional 2.7 grams of chicory root fiber coating is applied on the top side of the snack bar as the coating.

15. The snack bar of claim 14, wherein the top side additional coating of chicory root fiber on the bar is baked or broiled or similar with a heat treatment at a temperature of from about 250° F. to about 400° F. for about 1 to about 7 minutes to achieve the melting temperature of the chicory root fiber (preferably 352.4° F.) and melt the chicory root fiber to a pre caramelized status and form a uniform glossy surface.

16. The method of claim 15, further comprising cooling the bar.

17. The snack bar of claim 1, wherein an additional 2.7 grams of chicory root fiber coating is applied on the bottom side of the snack bar.

18. The snack bar of claim 17, wherein the bottom side of the bar is baked or broiled or similar with a heat treatment at a temperature of from about 250° F. to about 400° F. for about 1 to about 7 minutes to achieve the melting temperature of the chicory root fiber (preferably 352.4° F.) and melt the chicory root fiber to a pre caramelized status and form a uniform glossy surface.

19. The method of claim 18, further comprising cooling the bar.

20. The snack bar of claim 1, wherein the total amount of prebiotic fiber from the Chicory root fiber incorporated in and on the bar attributes to greater than 4 grams of prebiotic fiber in the snack bar.

21. The snack bar of claim 1 , further comprising the pieces of dried fruit, with or without nut pieces, chocolate, seeds probiotics, vitamins, minerals, spices, herbs, oils or any combination thereof, held together in the creamy, chewy grain composition by the binder, wherein the pieces of dried fruit, nuts pieces, chocolate, seeds, or combination thereof have an average diameter between about 4 to 16 mm and/or an average volume between 10 to 600 mm.

22. A method of making a snack bar with a non-baked core comprising: mixing chicory root fiber in a syrup and or honey composition having a temperature of below about 80° F. and heated up above 95° F. to completely dissolve the chicory root fiber in the syrup and or honey to form a binder slurry. Mixing the creamy, chewy grain composition comprising coconut cream with discrete dried fruit pieces, with or without nut pieces, chocolate, seeds, probiotic, vitamins, minerals, spices, herbs, and oils, with the binder slurry, forming a bar from the mixture of the creamy, chewy grain composition and the binder slurry.

23. The method of claim 22, further comprising 3 additional coatings of chicory root fiber on the snack bar resulting in the amount of prebiotic fiber from the chicory root fiber to more than 4 grams per serving.

24. The method of claim 22, further comprising baking or broiling or similar heat treatment to the bar at a temperature of from about 250° F. to about 400° F. (preferably 352.4° F.), top and bottom, for about 1 to about 7 minutes to melt the chicory root fiber to a pre caramelized status and form a uniform glossy surface.
